(19) United States
(12) Patent Application Publication
(10) Pub. No.: US 2013/0169390 A1
(43) Pub. Date: Jul. 4, 2013

(54) AUTOMOTIVE TRANSMISSION

(71) Applicant: Alejandro Leon, Humble, TX (US)

(72) Inventor: Alejandro Leon, Humble, TX (US)

(21) Appl. No.: 13/341,168

(22) Filed: Dec. 30, 2011

(51) Int. Cl. H01F 7/02; H01F 7/06

(52) U.S. Cl. 335/219

(57) ABSTRACT

A vehicle including a first magnetic device, and an engine having a rotating component on which the first magnetic device is located. The vehicle may also include a central processing computer, a second magnetic device, a first shaft, a second shaft, and wheels. The first magnetic device is adapted to generate a first electrical signal through the rotating movement of the first magnetic device on the rotating component of the engine. The first electrical signal is supplied to the central processing computer. The central processing computer is programmed to supply a second electrical signal to the second magnetic device. The second magnetic device creates a magnetic field in response to the second electrical signal which causes the first shaft to turn. The first shaft causes a second shaft to turn which turns the wheels.

### FIELD OF THE INVENTION

This invention relates to improved methods and apparatus concerning automobile engines and transmission.

### BACKGROUND OF THE INVENTION

Current automotive transmissions rely on the mechanical turning force created by the engine in order to turn the wheels.

### SUMMARY OF THE INVENTION

In at least one embodiment a vehicle is provided comprising a first magnetic device, and an engine having a rotating component on which the first magnetic device is located. The vehicle may also include a central processing computer, a second magnetic device, a first shaft, a second shaft, and wheels. The first magnetic device is adapted to generate a first electrical signal through the rotating movement of the first magnetic device on the rotating component of the engine. The first electrical signal is supplied to the central processing computer. The central processing computer is programmed to supply a second electrical signal to the second magnetic device. The second magnetic device creates a magnetic field in response to the second electrical signal which causes the first shaft to turn. The first shaft causes a second shaft to turn which turns the wheels.

The first magnetic device may be a permanent magnet, an electromagnet or another type of magnet. The vehicle may be an automobile. The vehicle may include a brake system, which communicates with the central processing computer. The vehicle may include an accelerator, which communicates with the central processing computer.

One or more embodiments of the present invention include a method comprising placing a first magnetic device on a rotating component of a vehicle engine in a vehicle, so that the first magnetic device rotates with the rotating component. The method may also include configuring a central processing computer so that it receives a first electrical signal due to the rotating of the first magnetic device on the rotating component of the vehicle engine. The method may also include placing a second magnetic device on board the vehicle so that the second magnetic device receives a second electrical signal from the central processing computer. The method may also include placing a first shaft on board the vehicle so that the first shaft turns in response to a magnetic field generated by the second magnetic device, and so that the first shaft turns a second shaft which turns a plurality of wheels on which the vehicle rolls.

### BRIEF DESCRIPTION OF THE DRAWINGS

FIG. 1 shows a block diagram of a prior art automotive transmission apparatus;

FIG. 2 shows a block diagram of an automotive transmission apparatus in accordance with an embodiment of the present invention;

FIG. 3 shows a frontal view of the magnet on the shaft and an electromagnet; and

FIG. 4 shows a cross sectional view of the components of FIG. 3;

### DETAILED DESCRIPTION OF THE DRAWINGS

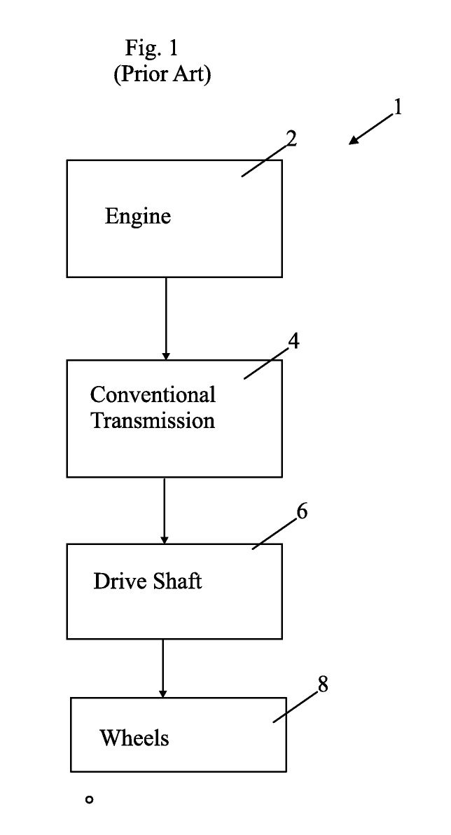

FIG. 1 shows a block diagram of a prior art automotive transmission apparatus 1. The apparatus 1 includes an engine 2, a conventional transmission 4, a drive shaft 6, and a plurality of wheels 8. The engine 2 may be any type of known passenger automobile engine, such as a known four, six, eight, ten, twelve, or sixteen cylinder passenger automobile engine. In other embodiments the apparatus 1 may be used in a motorcycle, airplane, boat, or tractor trailer and in that case the engine 2 would be a known engine for a motorcycle, airplane, boat, or tractor trailer.

The engine 2 may provide the conventional transmission 4 with mechanical torque. The conventional transmission 4 may be an automatically shifted or manually shifted automotive transmission, in the case of an automobile. The conventional transmission 4 may provide kinetic force in a circulatory movement to the drive shaft 6. The drive shaft may rotate to turn the wheels 8.

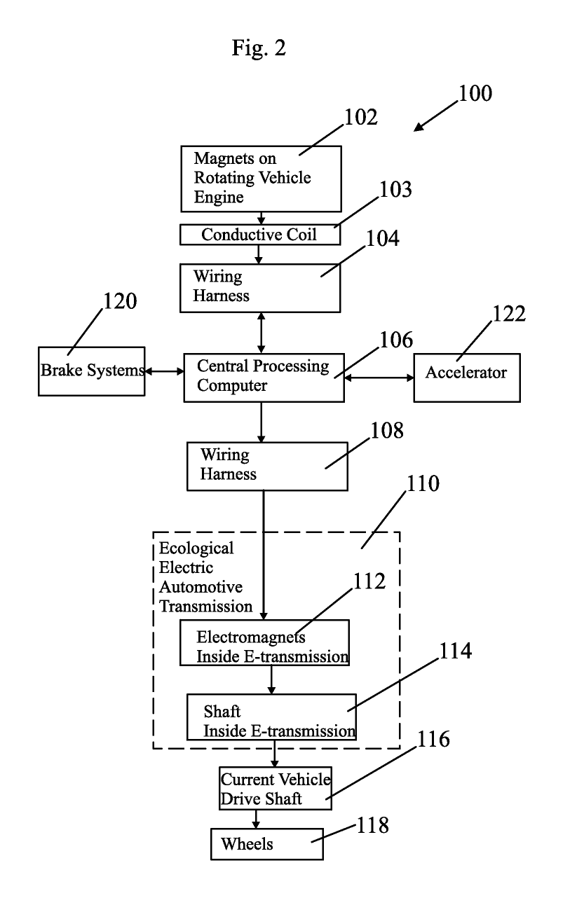

FIG. 2 shows a block diagram of an automotive transmission apparatus 100 in accordance with an embodiment of the present invention. The apparatus 100 includes magnets 102 on a rotating vehicle engine, a conductive coil 103, a wiring harness 104, central processing computer 106, a wiring harness 108, an ecological electric automotive transmission 110, electromagnets 112 inside transmission 110, a magnetic shaft 114 inside transmission 110, a current vehicle shaft 116, and wheels 118.

The ecological electric automotive transmission 110 may have only one forward gear and one reverse gear, because typically transmission 110 is not an internally geared transmission that relies on mechanical gears in order to raise vehicle speed. In at least one embodiment, the engine on which the magnets 102 rotate, may cause a disc or flywheel of the engine to rotate at a certain number of revolutions per minute. The magnets 102 may be attached to the disc or flywheel so that they also rotate at a certain number of revolutions per minute. The moving magnets 102 create a changing magnetic field which creates a changing electric field, and which through the principle of electromagnetic induction creates an electrical current in the conductive coil 103, wherein the conductive coil 103 is stationary. The electrical current generated in 103 flows through the wiring harness 104. The wiring harness 104 may be comprised of conductors, such as conductive wires.

The electrical current may flow through one or more on off switches in the central processing computer 106 to a wiring harness 108. The on-off switches in the central processing computer 106 may be controlled by the braking systems 120 and the accelerator 122. The electrical current may flow through the wiring harness 108 to the transmission 110. The electrical current may flow into the electromagnets 112 and cause a changing electrical field and thus a changing magnetic field to be created by a coil. The changing magnetic field may cause the magnetic shaft 114 to rotate. The magnetic shaft 114 may cause the current known vehicle drive shaft 116 to rotate. The current vehicle shaft 116 may rotate the wheels 118 of an automobile or other vehicle. Electromagnets 112 may be replaced by magnets which are not electromagnets and magnets 202 may be replaced by electromagnets. Non-permanent magnets can also be used in place of electromagnets 112 or magnets 202.

In at least one embodiment, the transmission 110 will not raise revolutions per minute of the rotating vehicle engine such as the engine on which the magnets 102 in FIG. 2 are located, while traveling at any speed, because typically the transmission 110 does not need mechanical torque to function, rather, it relies on the electricity now being produced by the magnets 102 in order to accelerate or decelerate its rotating speed. Known vehicle engine may produce enough electricity at its idle speed to supply the needs of the transmission 110 without having to accelerate the engine. Transmission 110 typically does not control revolutions of engine on which 102 are located.

The magnets 102 may be located on a known engine, such as any known engine for engine 2 of FIG. 1. The magnets 102 may be positioned at an angle and fixed on a rotating disc of a known engine to achieve electromagnetic induction in the conductive coil 103. The magnets 102 may be a conventional type of magnets.

The wiring harness 104 may be a a series of electric current inducing isolated wires, and may be made of conventional metals and may be located at a distance D1 from the magnets 102. The distance D1 may range from one quarter of an inch to one half of an inch in order that electromagnetic induction may occur in the wiring harness 104. The coil 103 may be able to be eliminated if induction is made to occur in the wiring harness 104 from the rotating magnets 102. The wiring harness 104 transmits electricity or electrical signals to central processing computer 106 for regulation of energy flow and discharge and distribution depending upon acceleration demand to the electromagnets 112 located within the interior of the ecological electric automotive transmission.

The central processing computer 106 may include computer memory, a computer processor, a computer display, and a computer interactive device. The computer interactive device of the central processing computer 106 may allow an operator to input information into the computer 106. In at least one embodiment, the central processing computer 106 receives signals from the accelerator 122 and/or from the brake systems 120. The accelerator 122 may be a known accelerator for an automobile. The brake systems 120 may be known brake systems for an automobile. In general, the central processing computer 106 may be caused to perform any of its functions by a computer program or software stored in a computer memory. The central computer processor 106 may store in computer memory data related to the signals from the accelerator 122 and/or the brake systems 120. The signals from the accelerator 122 and/or the brake systems 120 may relate to acceleration or deceleration rates of the automobile. The central computer processor 106 may be programmed by a computer program stored in computer memory to determine the energy demand required from the engine on which the magnets 102 rotate, based on acceleration or deceleration rates determined from the signals from the accelerator 122 and/or brake systems 120. If the central processing computer 106 determines that more energy is required, the central processing computer 106 may open one or more sections of the wiring harness 104 to cause an increase of electricity to the wiring harness 108 to reach the ecological electric automotive transmission 110 (and thereby the electromagnets 112 located within the interior walls 110a of the ecological electric automotive transmission 110.

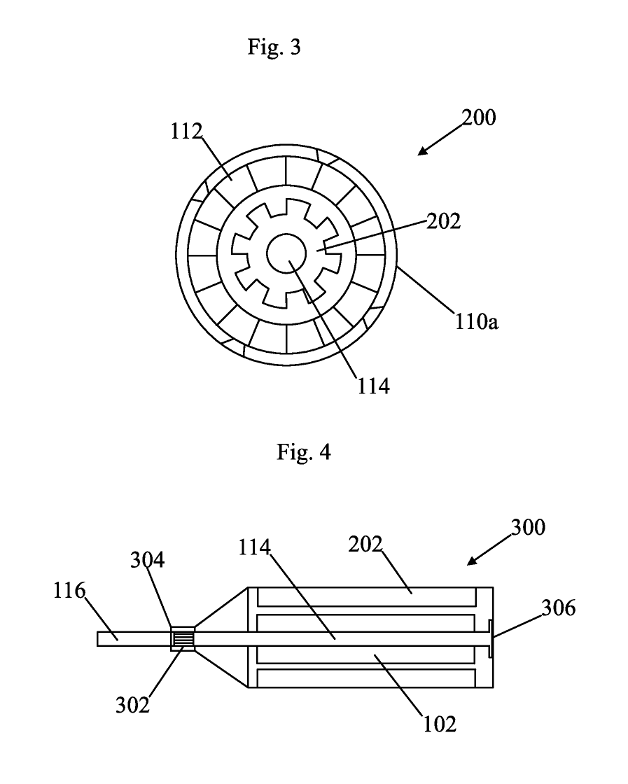

If the central processing computer 106 determines that less energy is required, the central processing computer 106 may close one or more sections of the wiring harness 104 to cause a decrease of electricity to the wiring harness 108 to reach the ecological electric automotive transmission 110 (and thereby the electromagnets 112 shown in FIG. 3, located within the interior walls 110a of the ecological electric automotive transmission 110)

The central processing computer 106 may supply an electrical signal to the wiring harness 108, which may be located separately from wiring harness 104 and may be a series of electric current inducing isolated wires made of conventional metals.

The wiring harness 108 may transmit the electrical signals or electricity to the ecological electric automotive transmission 110, which may be a metallic shell with enough volume to contain its parts and which may be located behind the engine and connected with the vehicle's main drive shaft. The wiring harness 108 transmits electrical signals to electromagnets 112 shown in FIGS. 3 and 4 and located in transmission 110.

The transmission 110 typically converts electrical energy into kinetic force by using electromagnets 112 affixed to the interior walls of the transmission 110 and converting this energy into and magnetic field causing a kinetic force upon magnets 202 which are affixed to shaft 114 inside the E-transmission 110 causing and creating rotating motion of shaft 114. The drive shaft 116 may be any known drive shaft. The drive shaft 116 may turn the wheels 118. The wheels 118 may be any known wheels of an automobile. The drive shaft 116 transmits rotating motion from transmission shaft 114 to wheels 118. Wheels 118 rotate thereby, to move a vehicle, such as an automobile.

FIG. 3 shows a diagram 200 of a frontal view of magnets 202 on the transmission shaft 114 and an electromagnet 112.

FIG. 4 shows a diagram 300 of a cross sectional view of the components of FIG. 3 and part of current drive shaft 116. FIG. 4 shows connecting mechanism 302 directed at E-transmission drive shaft 112, protective housing 304, and ball bearing base 306 directed at rotating transmission shaft 114.

Although the invention has been described by reference to particular illustrative embodiments thereof, many changes and modifications of the invention may become apparent to those skilled in the art without departing from the spirit and scope of the invention. It is therefore intended to include within this patent all such changes and modifications as may reasonably and properly be included within the scope of the present invention's contribution to the art.

I claim:

1. A vehicle comprising:
a first magnetic device;
an engine having a rotating component on which the first magnetic device is located;
a central processing computer;
a second magnetic device;
a first shaft;
a second shaft; and
a plurality of wheels on which the vehicle rolls;
wherein the first magnetic device is adapted to generate a first electrical signal through the rotating movement of the first magnetic device on the rotating component of the engine;
wherein the first electrical signal is supplied to the central processing computer;
wherein the central processing computer is programmed to supply a second electrical signal to the second magnetic device;
and wherein the second magnetic device creates a magnetic field in response to the second electrical signal which causes the first shaft to turn;
wherein the first shaft causes a second shaft to turn which turns the plurality of wheels.

2. The vehicle of claim 1 wherein
the first magnetic device is a permanent magnet.

3. The vehicle of claim 1 wherein
the first magnetic device is an electromagnet.

4. The vehicle of claim 1 wherein
the vehicle is an automobile.

5. The vehicle of claim 1 further comprising
a brake system, which communicates with the central processing computer.

6. The vehicle of claim 1 further comprising
an accelerator, which communicates with the central processing computer.

7. A method comprising the steps of
placing a first magnetic device on a rotating component of a vehicle engine in a vehicle, so that the first magnetic device rotates with the rotating component;
configuring a central processing computer so that it receives a first electrical signal due to the rotating of the first magnetic device on the rotating component of the vehicle engine;
placing a second magnetic device on board the vehicle so that the second magnetic device receives a second electrical signal from the central processing computer;
placing a first shaft on board the vehicle so that the first shaft turns in response to a magnetic field generated by the second magnetic device, and so that the first shaft turns a second shaft which turns a plurality of wheels on which the vehicle rolls.

8. The method of claim 7 wherein
the first magnetic device is a permanent magnet.

9. The method of claim 7 wherein
the first magnetic device is an electromagnet.

10. The method of claim 7 wherein
the vehicle is an automobile.

11. The method of claim 7 further comprising
configuring the central processing computer so that it is in communication with a braking system for the vehicle.

12. The method of claim 7 further comprising
configuring the central processing computer so that it is in communication with an accelerator for the vehicle.
